(19) United States
(12) Patent Application Publication
(10) Pub. No.: US 2009/0027164 A1
(43) Pub. Date: Jan. 29, 2009

(54) Medical information management system for medical institution

(76) Inventor: Hitoshi Hara, Tokyo (JP)

Correspondence Address: BERENATO, WHITE & STAVISH, LLC, 6550 ROCK SPRING DRIVE, SUITE 240, BETHESDA, MD, 20817, US

(21) Appl. No.: 11/878,445

(22) Filed: Jul. 24, 2007

(51) Int. Cl. H04B 7/00

(52) U.S. Cl. 340/10.1

(57) ABSTRACT

According to the present invention, a medical information management system comprises an IC tag reader terminal for information from an IC tag storing the information on the medical item delivered; a first IC tag reader-writer terminal for writing to the IC tag attached to the shipping medical item; an IC card reader-writer terminal for writing and/or reading to/from an IC card storing information on the patient or the medical staff a second IC tag reader-writer terminal for writing and/or reading to/from an IC tag of the medical item being disposed to the patient; an order server for receiving the information transmitted from the IC card reader-writer terminal and the second IC tag reader-writer terminal; and a SPD server for receiving the information transmitted from the IC tag reader terminal, the first IC tag reader-writer terminal, and the order server and summing up the respective inventory.

### FIELD OF THE INVENTION

The present invention relates to a medical information management system for medical institution, particularly to a medical information management system for medical institution having an IC-tag and an IC-card with an IC-tag and IC-chip.

### BACKGROUND OF THE INVENTION

Conventionally, various systems are known as a medical information management system for medical institution of this type; for example, in Japanese Patent Application Laid-Open Publication 2001-155098, description is made of a system that reads the content of the recipe, a name of a medical staff, a name of medical item, and a patient name via barcode, and manages the medical information.

In WO/2001/155098, description is made on a medical information management system used by assigning a wireless ID chip with a unique ID to a patient's registration card with each patient, given medicine, patient's case record, the contents of the medical disposal, and the like, respectively.

### SUMMARY OF THE INVENTION

As described above, various systems are known as the medical information management system for medical institution of the related art; for example, Japanese Patent Application Laid-Open Publication 2001-155098 describes a system for managing medical information via barcode, WO/2001/155098 describes a system for managing the medical information via wireless ID-chip, and each system is expected to have advantage originated from using the barcode or wireless ID-chip, respectively.

However, regarding the barcode or wireless ID-chip, their capacity of the information is limited, they can hold relatively less information, thereby it is difficult to manage the medical information based on enough amounts of data, resulting to the possibility of occurrence of medical accident caused by the less amounts of information.

The medical information on the medical items including such as drug is particularly important information, which affects the life and death, and the security, and therefore the information is desired to be accurate and detail.

The occurrence of the medical accident such as misassignment of the medical items or patient should not be acceptable, it is desired to avoid the occurrence of the medical accident. It is also necessary to prevent the illegal access to the medical item information, leakage of the personal information, plagiarization, cloning, and etc.

Further, for a hospital, the inventory management of the medical items and the like is also important, and yet further it is desired to create the document such as bill, account without mischarging.

Considering the aforementioned of the state of the art, the object of the present invention is to provide a medical information management system for medical institution, which can prevent from the medical accident on the medical items and make easy and secure the management of the inventory of the medical items, issuing a bill, and so on.

In order to solve the aforementioned technical problem, the present invention provides a configuration described below.

(1) According to the claim 1, there is provided a medical information management system for medical institution for medical institution comprising

an IC tag reader terminal having an IC tag reader means for reading information from an IC tag, which is attached to a medical item at its delivery to the warehouse of a medical facility and stores the information on the medical item;

a first IC tag reader-writer terminal having an IC tag reader-writer means for reading the information from the IC tag attached to the medical item at its shipping from the warehouse and writing the information on the destiny to the IC tag;

an IC card reader-writer terminal having both an IC chip reader-writer means for reading information from an IC chip, which stores the information on a patient or medical staff and contained in an IC card, and an IC tag reader-writer means, which is included in the IC card and reads the information from an IC tag storing the medical information on a patient and writes medical information on the patient to the IC tag;

an order server having a receiving means, which is connected to the IC card reader-writer terminal and the second IC tag reader-writer terminal and receives information transmitted from the IC card reader-writer terminal and the second IC tag reader-writer terminal, and a store means for storing the received information, a matching means for matching the information transmitted from the IC card reader-writer terminal with the information transmitted from the second IC tag reader-writer terminal, and a transmitting means for transmitting the stored information to a SPD server for summing up respective inventory item, when matching is obtained;

a SPD server having a receiving means, which is connected with the IC tag reader terminal, the first IC tag reader-writer terminal, and the order server and receives the information transmitted from the IC tag reader terminal, the first IC tag reader-writer terminal, and the order server, and a store means for storing the received information, and a summing up means for summing up the respective inventory items based on the stored information.

(2) According to the claim 2, there is provided a medical information management system for medical institution according to the claim 1, wherein

the aforementioned IC chip reader-writer means has a fingerprint detection means;

the IC card reader-writer terminal has a fingerprint reader means for reading the fingerprint by means of analyzing the fingerprint detected by the fingerprint detection portion, and a fingerprint matching means for matching the information on the finger print read by the fingerprint reader means with the fingerprint registered in the IC chip, and when matching is obtained, allows to output the information stored in the IC chip.

(3) According to the claim 3, there is provided a medical information management system for medical institution according to the claim 1, wherein the IC tag reader terminal with the IC tag reader means is an IC tag reader built-in mobile terminal.

(4) According to the claim 4, there is provided a medical information management system for medical institution according to the claim 1, wherein

the SPD server and the order server are connected with the medical account server for performing the medical account,

the medical account server has a receiving means the information transmitted from the SPD server and the order server, a store means for storing the received information, and a bill creating means for creating the bills of certain format for respective patient based on the stored information.

According to the present invention defined in claim 1, it is possible to prevent from the medical accident on the medical items, make easy and secure the management of the inventory of the medical items, and exterminate undesirable stocks.

According to the present invention defined in claim 2, in addition to the aforementioned advantage of the invention defined in claim 1, it is possible to prevent from the medical accident and leak of the medical information, by means of authorization through matching of finger prints.

According to the present invention defined in claim 3, in addition to the aforementioned advantage of the invention defined in claim 1, it is possible to omit the dedicated apparatus and use a general purpose mobile terminal with the built-in IC tag reader, since the IC tag reader terminal is an IC tag reader built-in mobile terminal.

According to the present invention defined in claim 4, in addition to the aforementioned advantage of the invention defined in claim 1, it is possible to issue bills automatically and prevent from the mischarging. Besides, it is also possible to calculate cost prices for respective patients and grasp them, based on the information in the medical account server.

### BRIEF DESCRIPTION OF THE DRAWING

FIG. 1 is an explanation view for schematically illustrating the medical information management system for medical institution according to the present invention;

FIG. 2 is an explanation view for illustrating the medical information management system for medical institution according to the present invention in detail;

FIG. 3 is an explanation view for illustrating explaining IC card shown in FIG. 1;

FIG. 4 is an explanation view for schematically illustrating the IC chip reader-writer means shown in FIG. 1; and

FIG. 5 is a flow chart for the medical information management system for medical institution according to the present invention.

### DETAILED DESCRIPTION OF THE PREFERRED EMBODIMENTS

Hereinafter, referring to the drawings which illustrate exemplary, embodiments according to the present invention are described.

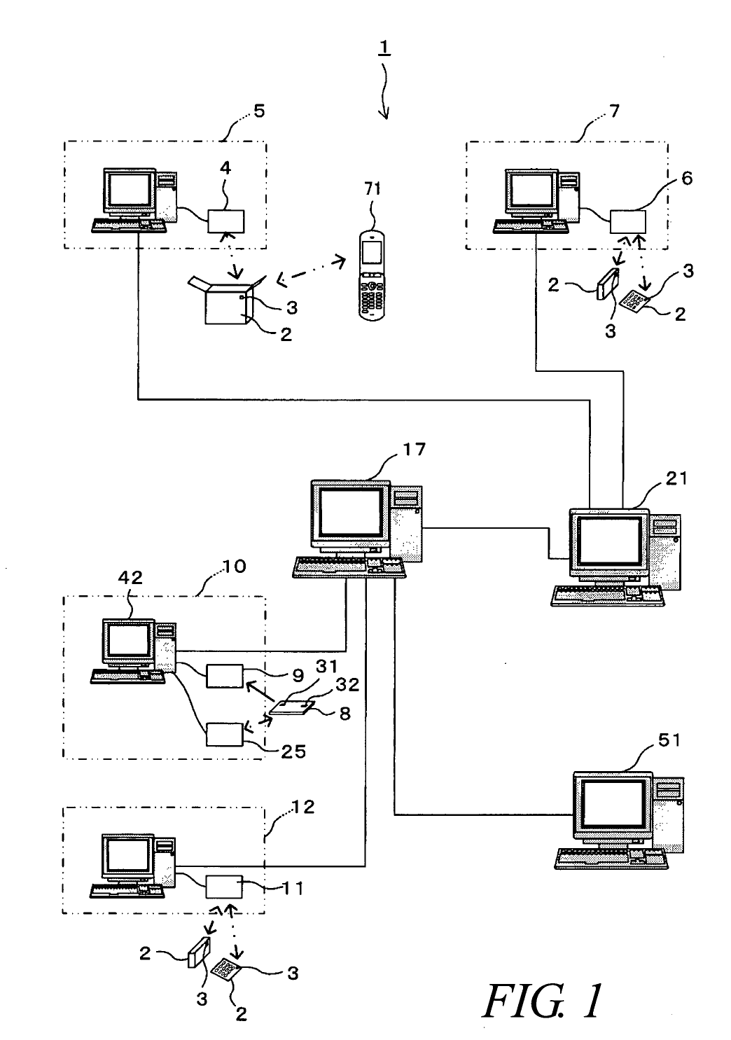

In FIGS. 1 & 2, symbol 1 denotes a medical information management system for medical institution, wherein, the medical information management system 1 comprises: an IC tag reader terminal 5 with an IC tag reader means 4 for reading one or a plurality of information on the medical items 2 (for example, information A, information B, information C, and the like) from an IC tag 3, which is attached to the medical items 2 such as pharmaceutical goods, treatment material, at their delivery to the hospital (not shown) and stores the information; and a first IC tag reader-writer terminal 7 with an IC tag reader-writer means 6 for reading the information from the IC tag 3 attached to the medical items 2 at the shipment of the medical item 2 and also writing the information on the destiny input by the outer operation to the IC tag 3.

Here, the IC tag 3 is associated with the medical items 2 itself and also the container, which accommodates one or a plurality of the medical items 2.

Besides, the IC tag reader means 4 and the IC tag reader-writer means 6 are also configured that: application programs not shown are installed to them; depending on the type of the application programs, reading and/or writing can be possible within the range for example, 5 cm, 5-10 m, more than 10 m from the IC tag 3; the type of the application program is selected depending on the using state of the IC tag reader 4 or IC tag reader-writer means 6. For example, in case that the distance between the IC tag reader means 4 or the IC tag reader-writer means 6 and the IC tag 3 becomes longer in the warehouse, selection is made on the application, which can read and/or write within relatively long distance such as 5-10 m, more than 10 m.

Here, although the IC tag reader means 4 comprises of, for example, a dedicated IC tag reader and the main body of the IC tag reader terminal 5 comprises of a computer, it is also possible to adopt the IC tag reader built-in mobile terminal 71 having function, which is obtained in the IC tag reader terminal 5 integrally containing the IC tag reader means 4, alternative to former configuration. It is also possible to include apparatuses with both configurations.

It is also possible that the IC tag reader means 4 comprises of an IC tag reader with a wireless communication function such as Bluetooth function and the main body of the IC tag reader terminal 5 comprises of a mobile terminal such as mobile phone capable of the wireless-communication with the IC tag reader.

Further, the medical information management system 1 comprises: an IC card reader-writer terminal 10 having an IC chip reader-writer means 9 for reading information from an IC chip 31, which is contained in the IC card 8 and stores medical information on a patient or a medical staff, and writing the information on the patient and the medical staff to the IC chip 31, and an IC tag reader-writer means 25 for reading information from an IC tag 32, which is contained in the IC card 8 and stores medical information of a patient, and writing the medical information on the patient input by the outer operation to the IC tag 32; a second IC tag reader-writer terminal 12 having a IC tag reader-writer means 11 for reading information from the IC tag 3 attached to the medical item 2 to be given to the patient and writing the information on the patient treated with the medical item 2; and an order server 17 connected with the IC card reader-writer terminal 10 and the second IC tag reader-writer terminal 12 over the network, wherein said order server 17 has a receiving means 13 for receiving the read information and/or written information transmitted from the IC card reader-writer terminal 10 and the second IC tag reader-writer terminal 12, and a store means for storing the received information, a matching means for matching the information transmitted from the IC card reader-writer terminal and the second IC tag reader-writer terminal 12, and a transmitting means 16 for transmitting the stored information to the SPD (Supply Processing & Distribution) server 21 described below, when matching is obtained.

Moreover, the medical information management system 1 comprises the SPD server 21 connected with the IC tag reader terminal 5, the first IC tag reader-writer terminal 7, and the order server 17 over the network such as LAN, wherein the SPD server 21 has a receiving means 18 for receiving the information transmitted from the IC tag reader terminal 5, the first IC tag reader-writer terminal 7, and the order server 17, a store means 19 for storing the received information, and a summing up means 20 for summing up respective inventory items based on the stored information.

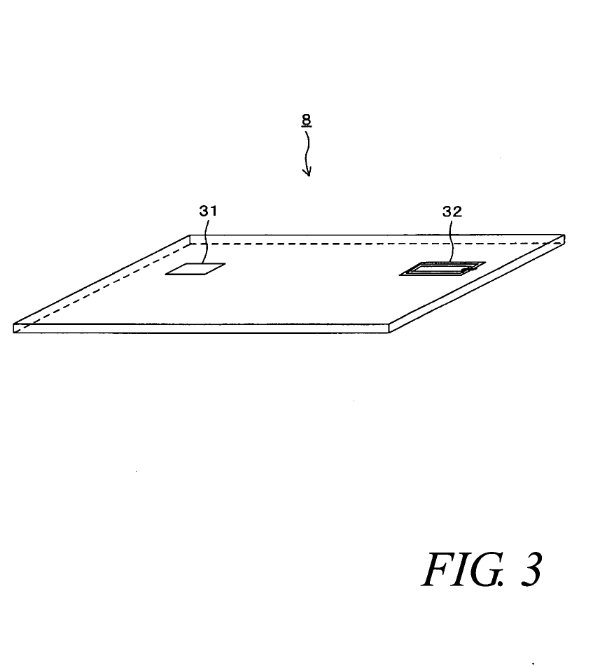

Besides, as shown in FIG. 3, the IC card 8 is provided with the IC chip 31 and the IC tag 32; the IC chip 31 mainly stores image data, for example, such as CT scan information, X-ray image information among the biometrical information such as finger print, and the medical information on the patient; and the IC tag 32 mainly stores the other medical information on the patient. Hereat, it is also possible that the IC card 8 brought by the medical staff is provided with only the IC chip 31.

Alternative to the IC card 8, it is also possible to use other memory media, for example, such as USB type memory, which is easy to handle. Moreover, it is desirable to encrypt the finger print information before registering it, particularly, the encryption follows the JIS (Japanese Industrial Standard) scheme.

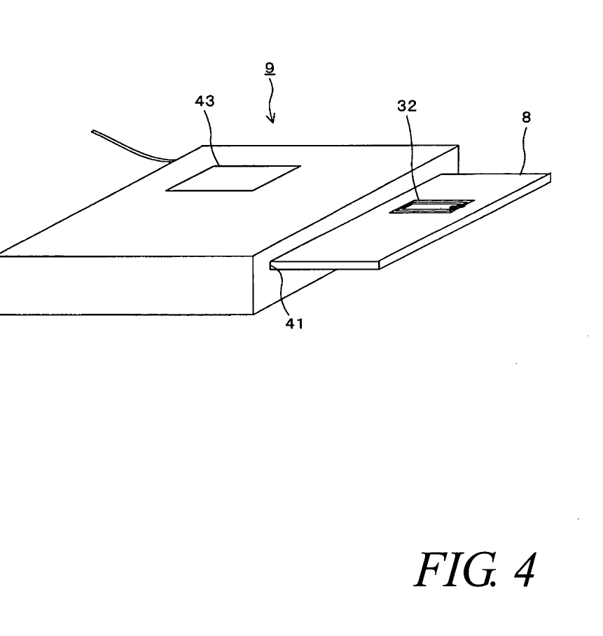

Furthermore, as shown in FIG. 1, the IC card reader-writer terminal 10 comprises: an IC chip reader-writer means 9 for reading and writing from/to the IC chip provided with the IC card 8; an IC tag reader-writer means 25 for reading information from the IC tag 32, which stores the medical information on the patient, and writing the medical information on the patient to the IC tag 32; and a computer 42 connected with the IC chip reader-writer means 9 and the IC tag reader-writer means 25, respectively; wherein the IC chip reader-writer means 9 has, as shown in FIG. 4, a slot 41 for being filled with the IC card 8, and a finger print detection portion 43 for detecting the finger print, the biometrical information.

Here, the IC chip reader-writer means 9 may comprise of a contactless IC chip reader-writer; and in such case, the slot 41 is unnecessary.

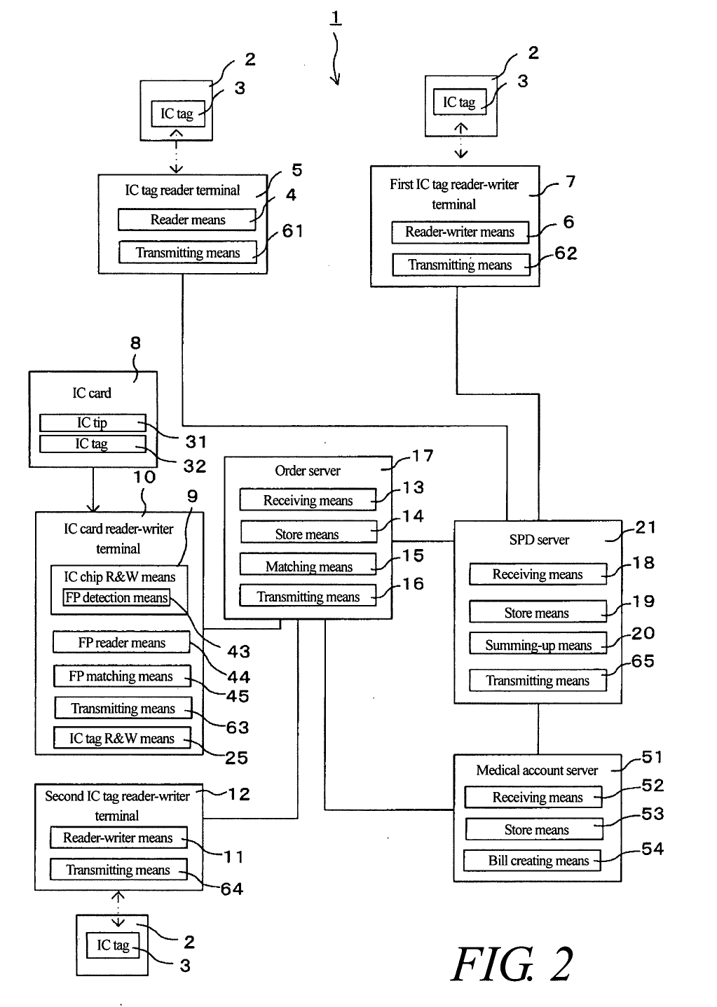

Further, as shown in FIG. 2, the IC card reader-writer terminal 10 has: a finger print reader means 44 for reading finger print by means of the analyzing the detected finger print pattern or reading likely; and a finger print matching means 45 for matching the finger print read by the finger print reader means 44 with that of being previous registered in the IC chip 31.

Yet further, the medical information management system 1 comprises that the SPD server 21 and the order server 17 are connected with a medical account server 51 for performing the medical account over the network, such as, LAN, wherein the medical account server 51 has a receiver means 52 for receiving the information transmitted from the SPD server 21 and the order server 17, a store means 53 for storing the received information, and a bill creating means 54 for creating a bill of certain format for each patient (not shown), based on the stored information.

Here, in case that the IC tag reader built-in mobile terminal 71 is used, the SPD server 21 is configured to be capable of communication with the IC tag reader built-in mobile terminal 71 over the internet.

Besides, although the IC tag reader terminal 5, the first IC tag reader-writer terminal 7, the IC card reader-writer terminal 10, the second IC tag reader-writer terminal 12, the order server 17, and the medical account server 51 are single in the medical information management system 1 respectively for the convenience of the explanation, practically, it is more likely that a plurality of apparatuses are provided as the respective terminals or servers.

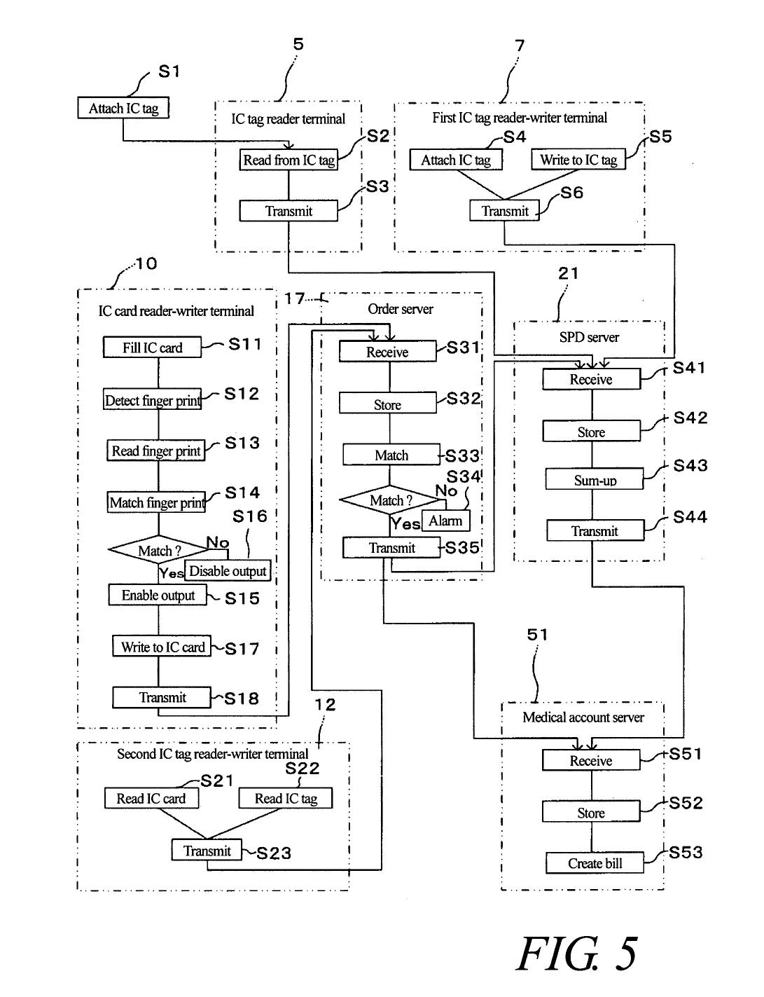

Now, referring to FIG. 5 associated with FIGS. 1 & 2, description is made on the processing of the medical information management system 1; to the medical item 2, IC tag 3 is adhered in advance during the fabrication process in the manufacturer or the delivery process in the wholesale dealer and the like (step S1); when the medical items 2 are delivered to the warehouse of medical facility (not shown), information stored in the IC tags 3 are read by the IC tag reader means 4 of the IC tag reader terminal 5, by means of putting the IC tag 3 to the IC tag reader means 4 within the distance of, for example, 5 cm (step S2); and the information is transmitted to the SPD server 21 by the transmitting means 61 provided with the IC tag reader terminal 5 (step S3).

Next, when the medical items 2 are shipped from the warehouse of the medical facility, the information stored in the IC tag 3 is read by the IC tag reader-writer means 6 of the first IC tag reader-writer terminal 7 (step S4); in addition, information on the destiny and the like are written to the IC tag 3 by the outer input (step S5); and the information is transmitted to the SPD server 21 by the transmitting means 62 provided with the first IC tag reader-writer terminal 7 (step S6).

In the meanwhile, IC cards 8 are assigned to respective patients and medical staffs, wherein the IC cards 8 contains IC chip 31, in which finger prints of respective patients and medical staffs is registered in advance; when a patient is going to have medical disposal carried out by a medical staff in the consultation room, the operation room, the clinic facility, and the like, the patient or the medical staff fills the IC chip reader-writer means 9 with their IC card 8 respectively (step S11). Correspondingly, the finger prints are detected by the finger print detection portion 43 of the IC chip reader-writer 9 (step S12). The finger print is read by the finger print reader means 44 of the IC card reader-writer terminal 10 by way of the analysis and the like of the detected one (step S13); the read finger print is matched with that of being registered in advance in the IC chip 31 by the finger print matching means 45 (step S14); in case that respective finger prints match, the information in the IC chip 31 is capable of being output, that is, outputting is allowed (step S15); and in case that respective finger prints does not match each other, the information in the IC chip 31 is not capable of being output (step S16).

In the meanwhile, the medical information on the patient is also read from the IC tag 32 by the IC tag reader-writer means 25. Then, when the patient has finished to have disposal such as medical examination and treatment, the content of the disposal is input together with the information on the (disposed) medical item 2 used for the disposal to the computer 42 by way of the input means of the computer 42, and the content is written to the IC chip 31 of the IC card 8 by the IC chip reader-writer means 9 (step S17). The content of the disposal is also written together with the information on the (disposed) medical item 2 to the IC tag 32 provided with the IC card 8 by the IC tag reader-writer means 25. Here, as mentioned above, the IC chip 31 mainly stores image data, for example, such as CT scan information, X-ray image information among the biometrical information such as finger print, and the medical information on the patient; and to the IC tag 32, the medical information on the patient is stored.

The transmitting means 63 provided with the IC card reader-writer terminal 10 transmits to the aforementioned order server 17 the information: the information output from the IC chip 31 of the IC card 8 to the computer 42, the information input to the computer 42 via the input means of the computer, and the information read from the IC tag 32 by the IC tag reader-writer means 25 (step S18).

On the other hand, when the patient has finished to have disposal such as medical examination and treatment carried out by the medical staff, the information stored in the IC tag 3 of the used (disposed) medical item 2 is read by the IC tag reader-writer means 11 of the second IC tag reader-writer terminal 12 (step S21); then the information, which is input by user operation and relates to the disposal such as treatment, is written to the IC tag 3 by the IC tag reader-writer means 11 (step S22); and the information is transmitted by the transmitting means 64 provided with the second IC tag reader-writer terminal 12 to the order server 17 (step S23).

Here, it is also possible to give the function of the IC tag reader-writer means 11 to the IC tag reader-writer means 25. In such case, if the function of the second IC tag reader-writer terminal 12 is given to the IC card reader-writer terminal 10, the IC tag reader-writer means 11 and the second IC tag reader-writer terminal 12 are unnecessary.

The order server 17 receives the information transmitted from the IC card reader-writer terminal 10 and the second IC tag reader-writer terminal 12 by means of the receiving means 13 (step S31), memorizes it by means of the store means 14 (step S32), matches the information transmitted from the IC card reader-writer terminal 10 and the second IC tag reader-writer terminal 12 by means of the matching means 15 (step S33), and in case of being mismatched, makes alarm (step S34). In case that the medical item 3 is changed to the other owing to the alarm, the order server 17 receives again the information transmitted from the second IC tag reader-writer terminal 12, and duplicates the processes of the aforementioned steps S31-S33. When matching is obtained, the order server 17 transmits the information to the SPD server 21 and medical account server 51 by means of the transmitting means 16 (step S35). Hereat, although illustration is omitted, the order server 17 separately receives the information from the first IC tag reader-writer terminal 7, the SPD server 21, the IC card reader-writer terminal 10, and the second IC tag reader-writer terminal 12, manages the divisional inventory through summing up, and then appropriately transmits the information for ordering the medical items to the SPD server 21.

The SPD server 21 receives the information transmitted from the IC tag reader terminal 5, the first IC tag reader-writer terminal 7, and the order server 17 by means of the receiving means 18 (step S41), memorizes the received information by means of the store means 19 (step S42), sums up respective inventory items based on the stored information by means of summing up means 20 (step S43), and then transmits the summed up result to the medical account server 51 by means of the transmitting means 65 provided with the SPD server 21 (step S44).

The medical account server 51 receives the information transmitted from the order server 17 and the SPD server 21 by means of the receiving means 52 (step S5]), memorizes the received information by means of the store means 53 (step S52), and creates the bills of certain format for respective patients by means of the account creating means 54 (step S53).

Hereat, the cost prices of the medical items necessary to create the bills are stored in the medical account server 51 or the SPD server 21 in advance; in case of stored in the SPI) server 21, it is appropriately transmitted from the SPD server 21 to the medical account server 51.

Besides, in case that the IC tag reader-writer means 5, 11, 25 work in the medical information management system 1, and they carry out merely reading from the IC tag, it is also possible to substitutionary use the aforementioned IC tag reader built-in mobile terminal, or the IC tag reader with the wireless communication function such as Bluetooth, associated with the mobile terminal, such as mobile phone, capable of the wireless communication with said IC tag reader. In such case, the IC tag reader built-in mobile terminal or the mobile terminal is configured so as to be connected with the SPD server 21, the computer of the second IC tag reader-writer means 12, and the computer 42 of the IC card reader-writer terminal 10 over the internet. Or, it is also possible to configure that the order server 17 is capable of the communication with the IC tag reader built-in mobile terminal or the mobile terminal over the internet, substitutionary to the configuration that the computer of the second IC tag reader-writer means 12 and the computer 42 of the IC card reader-writer terminal 10 are capable of communication over the internet

I claim:

1. A medical information management system for medical institution for medical institution comprising:
an IC tag reader terminal having an IC tag reader means for reading information from an IC tag, which is attached to a medical item at its delivery to the warehouse of a medical facility and stores the information on the medical item;
a first IC tag reader-writer terminal having an IC tag reader-writer means for reading the information from the IC tag attached to the medical item at its shipping from the warehouse and writing the information on the destiny to the IC tag;
an IC card reader-writer terminal having both an IC chip reader-writer means for reading information from an IC chip, which stores the information on a patient or medical staff and contained in an IC card, and an IC tag reader-writer means, which is included in the IC card and reads the information from an IC tag storing the medical information on a patient and writes medical information on the patient to the IC tag;
an order server having a receiving means, which is connected to the IC card reader-writer terminal and the second IC tag reader-writer terminal and receives information transmitted from the IC card reader-writer terminal and the second IC tag reader-writer terminal, and a store means for storing the received information, a matching means for matching the information transmitted from the IC card reader-writer terminal with the information transmitted from the second IC tag reader-writer terminal, and a transmitting means for transmitting the stored information to a SPD server for summing up respective inventory item, when matching is obtained;
a SPD server having a receiving means, which is connected with the IC tag reader terminal, the first IC tag reader-writer terminal, and the order server and receives the information transmitted from the IC tag reader terminal, the first IC tag reader-writer terminal, and the order server, and a store means for storing the received information, and a summing up means for summing up the respective inventory items based on the stored information.

2. A medical information management system for medical institution according to claim 1, wherein
the aforementioned IC chip reader-writer means has a fingerprint detection means;
the IC card reader-writer terminal has a fingerprint reader means for reading the fingerprint by means of analyzing the fingerprint detected by the fingerprint detection portion, and a fingerprint matching means for matching the information on the finger print read by the fingerprint reader means with the fingerprint registered in the IC chip, and when matching is obtained, allows to output the information stored in the IC chip.

3. A medical information management system for medical institution according to claim 1, wherein the IC tag reader terminal with the IC tag reader means is an IC tag reader built-in mobile terminal.

4. A medical information management system for medical institution according to claim 1, wherein
the SPD server and the order server are connected with the medical account server for performing the medical account,
the medical account server has a receiving means the information transmitted from the SPD server and the order server, a store means for storing the
received information, and a bill creating means for creating the bills of certain format for respective patient based on the stored information.
